(19) United States
(12) Patent Application Publication
(10) Pub. No.: US 2015/0103371 A1
(43) Pub. Date: Apr. 16, 2015

(54) SYSTEM AND METHOD FOR TRACEABILITY OF CHECKS WITH IMPROVED FUNCTIONALITIES, AND RELATIVE DIGITAL SCANNER

(71) Applicant: Panini S.p.A., Torino (TO) (IT)

(72) Inventor: Pierpaolo BUBBIO, Torino (IT)

(73) Assignee: Panini S.p.A., Torino (TO) (IT)

(21) Appl. No.: 14/055,591

(22) Filed: Oct. 16, 2013

(51) Int. Cl. H04N 1/00; G06Q 20/32; G06Q 20/10; G06Q 20/04

(52) U.S. Cl. CPC H04N 1/00307; H04N 1/00225; G06Q 20/0425; G06Q 20/325; G06Q 40/02; G06Q 20/108; G06Q 20/3224; H04N 2201/0081; H04N 2201/3281
USPC 358/1.15

(57) ABSTRACT

A digital check scanner (1) is associated with a receiver adapted to receive a message (22) from a transceiver station (20) belonging to a cellular network, such message (22) including geographic position information.

The present invention relates to a system and a method for the traceability of checks with improved functionalities, and relative digital scanner. More specifically, the present invention relates to a digital check scanner, a system and a method for the traceability of checks in order to verify their reliability and to comply with national and international laws regarding the currency circulation.

Nowadays the electronic money transactions are widespread, it should be considered how the ATM cards and credit cards are spreading more than the circulation of cash.

Another well-known method of payment is related to checks. An American law known as “Check21” approved by former U.S. President George W. Bush and in force in the U.S. since October 2003, has famously made legal the digital transmission of a check and its printing at destination as a substitution check, referred to as “substitution check”, and to all intents and purposes, to be considered equivalent to the original check. Since the physical printing of the paper substitution check is not strictly necessary, the “Check21” law has effectively promoted the legality of the image of a check, captured by a digital scanner which is mainly specialized in this task (also referred to as “check scanner”) and which also implements the ability to read and decode the magnetic “codeline” MICR (“Magnetic Ink Character Recognition”) reported on the bottom of the check itself.

The opportunity to legally transfer a check using its own digital image was evidently of great impact in terms of simplification and acceleration of banking transactions. Furthermore, supported and promoted by the banks themselves, it has been gradually extending a phenomenon called RDC (“Remote Deposit Capture”) which provides for the opportunity for all the U.S. companies, that receive checks as form of payment, to digitally pay the same to their account without physically going to the bank counter; this benefit, together with a large surface area and a number of small and medium-sized companies consisting of a few people, promises a real revolution and a “second youth” for the check itself, transformed at its origin in a digital data stream alike forms of payment much more recent and expensive as credit cards or debit cards.

In fact, the RDC and the possibility of remote payment of the check has also given a more important meaning to a series of obligations provided from banks and financial institutions; the “Patriot Act” and “Anti Money Laundering Act” laws require that the reception of money transactions by check or other payment systems should be monitored (the initiative is part of the concept known as “know your customer”), even and especially with regard to the geographical location from which the transaction takes place, or at unless the relevant geographical area. The ubiquity of the RDC indeed makes it perfectly possible for a malicious client to adhere to the RDC initiative of one or more U.S. banks, signing the relevant contract having the right of gratuitous loan for use (or otherwise) a check scanner through which make the remote transfer, and then physically transfer the scanner itself in any geographical area, from which it is possible to transfer money by sending checks in a digital format, without being subject to any control or restriction. These transactions may violate U.S. laws if they came from countries belonging to a “black list” and, thanks to the fact that an Internet connection can now be obtained in a completely anonymous way difficult to be verified, it may be very difficult for the bank to reliably trace back to the Country from where the payment comes from.

The main two surveys to be analyzed are: a first case (more prevalent at the moment) wherein the digital check scanner is piloted by a processor using API interfaces (“Application Program Interface”), and a second case (emerging, and much more interesting) wherein the digital check scanner has an autonomous working and can transfer the digitized data of the check via Wi-Fi (“Wireless Fidelity”), Bluetooth or other methods to an external heterogeneous device from the point of view of the operating system and hardware, such as a smartphone, a tablet, a POS terminal (“Point Of Sale”), a cash register, or directly to a destination located in a remote memory, also known as “cloud”. All the above is usually done by accessing to the bank through its web portal and, therefore, under conditions where the receiving bank has no opportunity to control and install a local software dedicated thereto.

In the first above mentioned case, i.e. wherein the scanner is connected to a processor, the geo-referencing of the check scanner coincides with the geo-referencing of the processor that controls it, which is supposed to be connected to the network at least during the transfer of the check data to the bank. Understanding “where is” a processor connected to the web is easy and today's technology offers several approaches. Unfortunately, none of these is solid when approached from the point of view of a suspicious person who intends to circumvent it. Checking the source of the IP address (“Internet Protocol”) from where the connection to the bank comes, it is possible using geographic detecting services of the IP addresses provided by different third companies. However, the use of a proxy server allows anyone to bring up the connection as coming from very different areas from the real ones. Always in the presence of an Internet connection, it is possible to do some triangulation of packages, usually with a ICMP protocol (“Internet Control Message Protocol”) with PING type utilities, and analyze their bounce times to try to deduce the same geographic position; however it is a very uncertain business and easy to be circumvented, in addition to the fact that the majority of IT (“Information Technology”) managers of the network service companies disables the rebound of this kind of packets to prevent DoS (“Denial of Service”) type attacks.

Additionally, some service companies have mapped a large part of the Wi-Fi networks available in various geographical areas and therefore their presence can be helpful to identify the area of interest with a good approximation. However, this type of networks has a large uncertainty through the time and their presence is limited to densely populated areas.

Finally, the possibility of the processor to be equipped with a GPS (“Global Positioning System”) module has the disadvantage of the lack of coverage in covered or closed areas in many homes and offices interiors, in the presence of skyscrapers or shielding structures.

Turning to the second mentioned case, i.e. wherein the check scanner does not need API interfaces to operate since it is directly accessible via Wi-Fi, Bluetooth, or other types of connection, the argument becomes even more complicated. In fact, the scanner must independently obtain

geo-location information and send them outside in a sufficiently secure manner (separately, or together with the data transfer related to checks) and without being able to count on a direct access to the Internet or specialized software.

It is therefore one object of the present invention to indicate a system and a method for traceability of checks with improved functionalities and relative digital scanner, which allow to detect information on their geographic position in an autonomous way.

It is a second object of the present invention to provide a system and a method for traceability of checks with improved functionalities and relative digital scanner, which allow to detect information about their geographic position with an accuracy of detection sufficient to ensure the bank that the transmission of the check came from areas not subject to restrictions.

It is a third object of the present invention to provide a system and a method for traceability of checks with improved functionalities and relative digital scanner, which allow to comply with the national and international regulations in matters of currency circulation.

These and other objects of the invention are achieved with a system and a method for traceability of checks with improved functionalities and relative digital scanner as claimed in the appended claims which form an integral part of the present description.

In short, the invention relates to a system and a method for traceability of checks with improved functionalities and relative digital scanner, wherein the digital check scanner is configured to receive, by the reception means, a message, in particular of a broadcast type, issued by a transceiver station belonging to a cellular network, and to derive information of geographic position from said message.

The present invention is therefore based on the presence of one or more cellular networks, in particular those telephone GSM (“Global System for Mobile Communications”), scattered in the territory. For each cell corresponds a transceiver station referred to as BTS (“Base Transceiver Station”) belonging to different operators or service providers. These cells provide a crosslinked radio coverage, i.e. they are arranged in such a way as to leave no “dead zones” of coverage, especially in populated areas. The area covered by a cell, or cellule, can vary from a few tens of Km in open spaces, up to 1-2 Km in urban spaces, therefore the cellule density of each operator will be chosen in an appropriate manner. Nowadays, any cellular mobile terminal with a GSM mobile digital technology (or 2.5G, 3G or 4G and operating with one of the most common bands such as GSM-900, GSM-1800, GSM-850, GSM-1900) must perform a series of operations to ensure its natural functioning. During the turn-on phase, or in non-operating condition, or “Idle”, a cell phone constantly keeps an updated list of neighboring cells among which from time to time the one that provides the best signal (and thus is presumably more close to the phone) will be selected. This activity is transparent and is the basis of the principle that allows to make and receive phone calls or exchange data when you are moving, without thinking about how the cell phone is connecting to the mobile phone network.

This allows to know from which place (geographic position) the electronic track of the check is sent and to withhold any money transactions not allowed for spatial constraints dictated by national and international laws relating to currency circulation.

Further characteristics of the invention are object of the appended claims which are considered an integral part of the present description.

The above objects will become more apparent from the detailed description of a system and a method for traceability of checks with improved functionalities and relative digital scanner with particular reference to the accompanying drawings wherein:

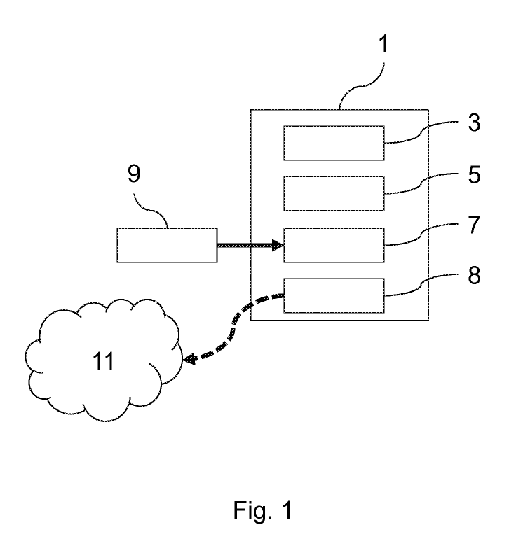

FIG. 1 illustrates a block diagram of a digital check scanner according to the present invention;

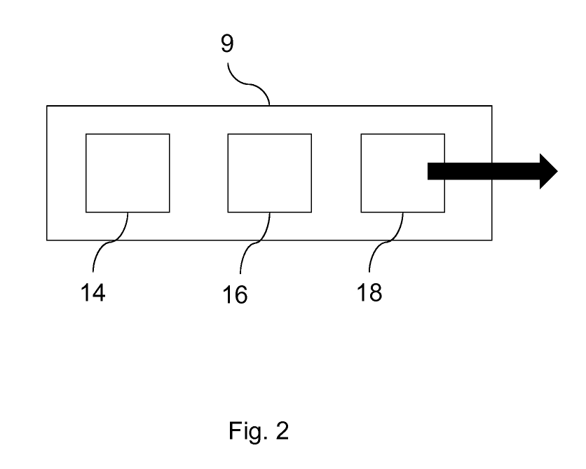

FIG. 2 shows a geographic detecting device in accordance with the present invention;

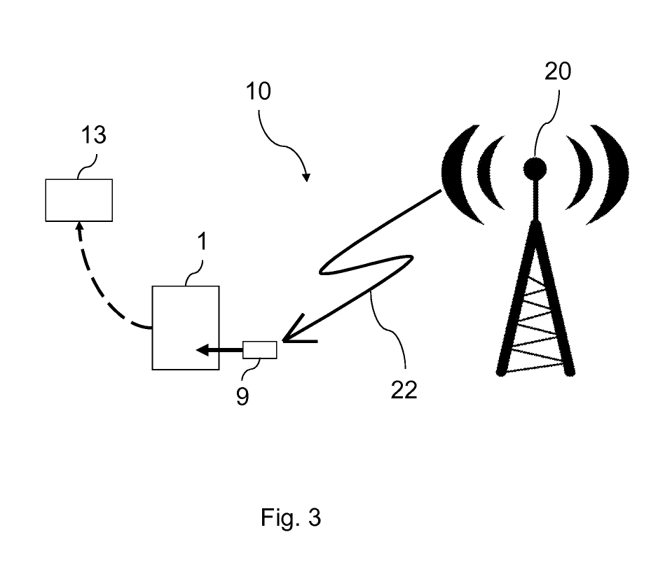

FIG. 3 illustrates a system for the traceability of checks in accordance with the present invention;

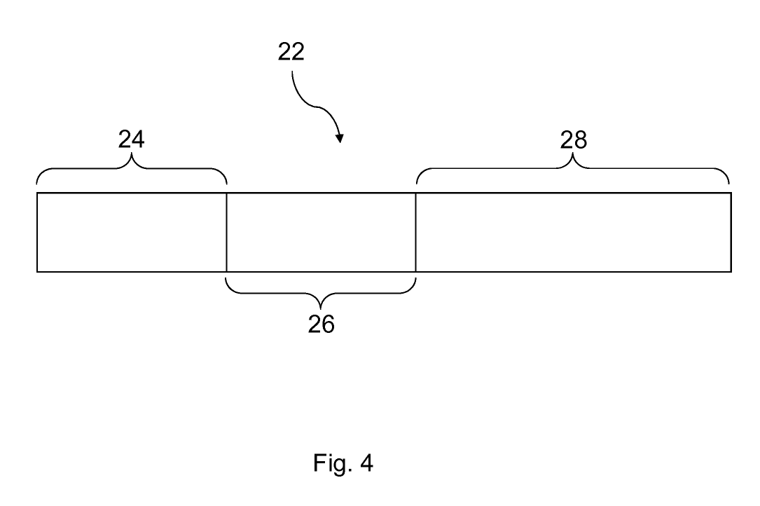

FIG. 4 shows an example of data received from a digital check scanner;

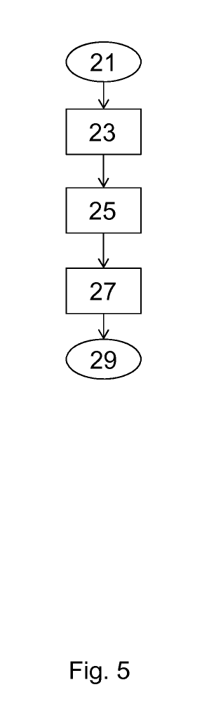

FIG. 5 illustrates a first flowchart of a method according to the invention;

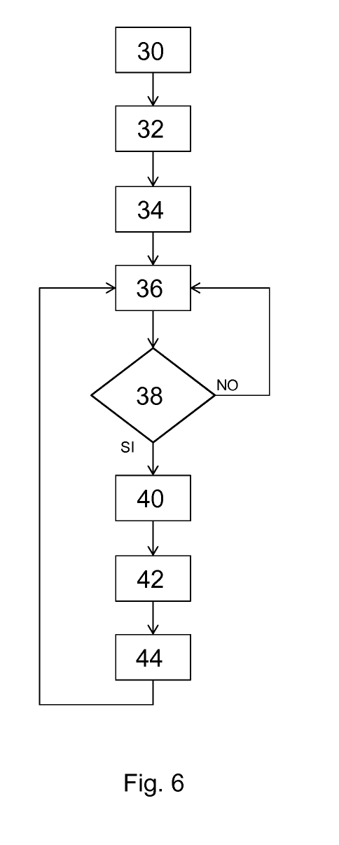

FIG. 6 illustrates a second flowchart of a method according to the invention;

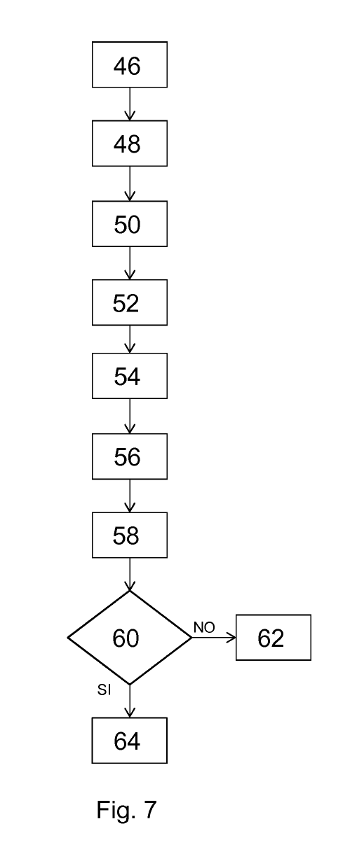

FIG. 7 shows a third flowchart of a method applied to a money transaction according to the present invention.

With reference to FIG. 1, it is illustrated a block diagram of a digital check scanner 1 comprising scanning means 3 of an image of said check. It may also include reading means 5 of an optical and/or magnetic code, for example, the MICR code of the check.

The digital scanner 1 optionally comprises first interfacing means 7, in particular of a USB (“Universal Serial Bus”) and/or Ethernet type for wired connections with external electronic devices, or Wi-Fi (“Wireless Fidelity”), Wi-Fi Direct and Bluetooth for wireless connections. It should be understood that other types of interfaces can be implemented. Therefore, the digital scanner 1 is addressable through an IP (“Internet Protocol”) address, preferably configurable by an external electronic device which can control the digital scanner 1 in all of its functions using the HTTP (“Hyper Text Transfer Protocol”) or HTTPS (encrypted HTTP) communication protocol.

The digital scanner 1 also includes transmission means 8 adapted to transmit the data of a check in an electronic digital format. The transmission means 8 allow to connect the digital scanner 1 to a web 11 and to this purpose they can exploit the first interfacing means 7, in particular an Ethernet or Wi-Fi interface. It should be noted that, the digital scanner 1 also includes a processing and control unit (not shown in the figures), which manages all the elements present therein.

In a first embodiment of the present invention, the digital check scanner 1 is connected to geographic detecting means 9, which are preferably an electronic module (also called “Dongle”) of a connected type (“wired”), for example USB, which can be connected to a USB port of the first interfacing means 7 of the digital check scanner 1.

The geographic detecting means 9 may be a geographic electronic module of a connected or wireless type (“wired” or “wireless”).

With reference to FIG. 2, these geographic detecting means 9 preferably comprise reception means 14, a processing/encryption module 16 and second interfacing means 18. Therefore, if it is assumed that the geographic detecting means are a USB Flash Drive, or a similar external electronic device, they can be connected to the digital check scanner 1 via the second interfacing means 18 connected to the first interfacing means 7, in a connected or wireless mode (“wired” or “wireless”), such as USB or Bluetooth, or Wi-Fi, or PCMCIA (“Personal Computer Memory Card International Association”), or SD (“Secure Digital”), or microSD, or other serial or parallel communication system best suited to the case.

With reference to FIG. 3, it shows a system 10 according to the present invention. The system 10 comprises the digital check scanner 1, connected to the geographic detecting means 9, and at least one transceiver station 20, preferably a radio base station belonging to a cellular telephone network, in particular the GSM one. The transceiver station 20 corresponds to a cell in the cellular network that offers a specific radio coverage. Each transceiver station 20 provides to periodically transmit a message 22 containing information about the geographic position. Particularly, in the GSM standard, it is expected that each cell to perform a periodic transmission of a broadcast type of that message 22 on a control channel, also known as BCCH (“Broadcast Control Channel”). Such a message 22 also serves the purpose of informing a mobile terminal regarding the presence of the cell and allowing it to prepare for the subsequent phases of recording on the telephone network.

The system 10 also includes a processor 13 of an entity authorized to read the position information sent thereto by the digital scanner 1, for example through the web 11. In the following it will be more apparent the task of said processor 13.

With reference to FIG. 4, it shows an example of a message 22 sent by a transceiver station 20. The message 22 includes information about the geographic position; said information of geographic position includes a first section 24 which identifies the Country in which the transceiver station 20 is located, and a second section 26 which identifies the “service provider”, i.e. the service provider of the cellular network. It is assumed the use of a transceiver station 20 of the GSM network, then as part of the message information made available through the BCCH 22, are the LAI (“Location Area Identity”) identifier, and the Cell ID (“Cell Identity”). Each area of the PLMN (“Public Land Mobile Network”) network is marked by a unique identifier referred to as just LAI, which is used to drive the update of the location by a mobile terminal. The LAI identifier is composed of three parts: the MCC (“Mobile Country Code”) code, the MNC (“Mobile Network Code”) code and the LAC (“Location Area Code”) code.

The MCC and MNC codes are usually used in pairs (MCC/MNC) and uniquely identify a Country and a “service provider”, for example, the pair 222-01 identifies the Country of Italy (MCC=222) and the Telecom Italia provider (MNC=01). An example of MCC/MNC codes is available at the following website:

http://en.wikipedia.org/wiki/Mobile_country_code.

Therefore, the first section 24 and second section 26 of the message 22 comprise information on the geographic position of the tranceiver station 20. The digital scanner 1 is adapted to receive such a message 22 by the reception means 14 of the geographic detecting module 9.

The geographic position information contained in the first section 24 and second section 26 is sufficient to allow to state that the cell that is sending the broadcast message 22 is located in a specific Country and that the operator of the cell is between those active in that Country, satisfying the instructions provided by the aforementioned “Anti Money Laundering Act.”

It should be noted that any information about the geographic position indicates the place where the transceiver station 20 is located, which is the same place where the digital scanner 1 receiving the message 22 is located.

Optionally, it is possible to use other available information contained in the message 22, as mentioned above, it may include a third section 28 that identifies a unique code of the transceiver station 20. In the GSM network, the third section 28 corresponds to the Cell ID code, this is a unique number that identifies the radio base station (BTS) in the GSM network. Thanks to the Cell ID and with the help of the MCC and MNC codes, it is possible to access to specialized databases of Cell ID (public or private) that contain the exact geographic position of the cell itself; in that case it is possible to know the exact position of the place where the transceiver station 20 is located, and therefore where the digital scanner 1 is, with a much higher accuracy, at most a few kilometers of radius (the accuracy depends on the size of the radio coverage of the cell).

It should be noted that the message 22 comprises at least one of said information about the geographic position, namely the first section 24 that identifies the Country, the second section 26 that identifies a service provider of said cellular network and the third section 28 that uniquely identifies the transceiver station 20.

In other words, the reception means 14 are adapted to receive the message 22 generated by at least one transceiver station 20 belonging to a cellular network. Advantageously, the reception means 14 may not require a SIM (“Subscriber Identity Module”) since the reception of the message 22 of a broadcast type does not require the opening of a communication channel or the recording of the reception means 14 on the cellular network.

The processing/encryption module 16, which interface the reception means 14, manages an initialization phase of the same, periodically receives information of geographic position contained in the message 22, and encodes them with an encryption algorithm (such as RSA, or “Rivest, Shamir and Adleman”) to make the content unreadable/alterable, since said encrypted geographic position information will be sent through the digital scanner 1, to an institution authorized to read them (usually a bank or other institution).

In fact, the second interfacing means 18 are the gateway to communicate to the outside the received and encrypted geographic position information, virtually to the digital check scanner 1 that will communicate this geographic position information through the transmission means 8.

In this first embodiment, the digital scanner 1 operates in a standalone mode and by the geographic detecting means 9, such as a USB flash drive, directly and periodically derived information about the own geographic position.

Being able to get own geographic position, the digital check scanner 1 can be configured to operate only in a particular geographical area, possibly determined at the planning step before being assigned to a customer. For example, the determined geographical area may correspond to that of the residence area of the customer. The digital check scanner 1 is also configured to stop its operation if the geographic position detected by the geographic detecting means 9 (i.e., the geographic position of the digital scanner 1) is not included in the determined geographical area in the digital scanner 1. In this way, the digital check scanner 1 automatically locks the electronic money transaction, if an operation of the digital scanner 1 occurs outside the geographical area permitted, thus avoiding potential fraudulent activities or prohibited by law.

Furthermore, the digital check scanner 1 is adapted to detect the presence or absence of the geographic detecting means 9, in particular of the USB flash drive, and protect itself against attempts of replacement, removal or tampering of the same. In this case, the digital scanner 1 automatically locks itself.

In a second embodiment, the geographic detecting means 9 are included in the digital check scanner 1. More in detail, the digital scanner 1 comprises reception means 14, in particular, they can be integrated directly on its electronic card.

As already mentioned, the digital scanner 1 comprises a processing and control unit (not shown in the figures) that manages all the elements therein, therefore it can be configured to receive the position information from the reception means 14 and to encode them using an encryption algorithm. Thus, the processing and control unit of the digital scanner 1 has the same described functions of the processing/encryption means 16.

It should be understood, moreover, that the second interfacing means 18 are no longer needed in this second embodiment, since there are the first interfacing means 7 for communicating with the outside, for example through the web 11.

Generally, it is possible to say that the digital check scanner 1 is configured to receive, by the reception means 14 associated thereto, a message, in particular of a broadcast type, emitted by at least one transceiver station 20 belonging to a cellular network, and to encode the information of geographic position obtained from said message.

It should be noted that the digital scanner 1 receives the message 22 from at least one transceiver station 20 because, being the cellular radio coverage a crosslinked coverage, the geographic point where the digital scanner 1 is located can be covered by a plurality of cells. Therefore, in this case, the digital scanner 1 would receive at least one message 22 from at least one transceiver station 20.

Additionally, the digital scanner 1 sends the encrypted position information to the processor 13 of an entity in charge of reading them, such as a bank. Such a processor 13 is arranged to:
decrypt a digital stream (it includes an electronic track of a check and the information of geographic position) in order to extract the information of geographic position;
transform the information of geographic position in geographical coordinates, particularly latitude and longitude;
check if a geographical area identified by the geographical coordinates is allowed for an electronic money transaction from that check;
accept the electronic money transaction if the geographical area is permitted;
reject the electronic money transaction if the geographical area is not permitted.

With reference to FIG. 5, the method according to the present invention begins at step 21 and provides:
(Step 23) to receive, by the reception means 14 associated with the digital check scanner 1, a message 22 sent from at least one transceiver station 20 belonging to a cellular network.

Additionally, the method according to the invention provides:
(Step 25) to encrypt, by processing/encryption means 16 associated with the digital scanner 1, geographic position information obtained by said message 22;
(Step 27) to transmit through the transmission means 8 of said digital check scanner 1, said encrypted geographic position information to an entity authorized to read them (e.g. a bank). The method ends at step 29.

With reference to FIG. 6, it shows a first flowchart of a method according to the invention. This first flowchart is applicable to both the first and the second embodiment of the invention described above.

At step 30, the digital scanner 1 is turned on (thus also the geographic detecting means 9 of the first embodiment of the invention are turned on), at step 32 occurs a phase of initialization of the processing/encryption means 16 and possibly of the first interfacing means 7 and second interfacing means 18. Subsequently, at step 34, the reception means 14 are initialized.

At step 36, the method provides to receive, by the reception means 14 associated with the digital check scanner 1, a message 22 sent from at least one transceiver station 20 belonging to a cellular network.

At step 38, if the digital scanner 1 has found at least one cell from which it has received the message 22, it proceed to step 40, otherwise it returns to the above mentioned step 36.

At step 40, the processing/encryption means 16 (external or internal to the digital check scanner 1) extract the geographic position information from the message 22, particularly a first section 24 containing a code of a Country, and/or a second section containing the code of the network service provider. If the cellular network is a GSM network, the message 22 comprises the LAI identifier, which in turn comprises the MCC code representing the Country (for example, the code 222 of Italy), the MNC code representing the service provider (for example, the code 10 which identifies the provider Telecom Italia). Optionally, the processing/encryption means 16 extract from the message 22 also the third section 28 (Cell ID code in the GSM network) in order to obtain with greater detail the geographic position of the transceiver station 20.

At step 42, the processing/encryption means 16 encode the geographic position information (one or more of said codes in case of GSM network) with an encryption algorithm such as RSA.

Finally, at step 44, the encrypted geographic position information is sent to an entity authorized to read them.

Subsequently, the operation goes back to step 36.

In the case wherein the geographic position information comprise only the third section 28 that uniquely identifies the transceiver station 20 within the cellular network, the authorized entity would receive this information and would be able to obtain the actual geographic position of the transceiver station 20 accessing to a database (public or private) that contains the listings of all the transceiver stations 20 of the network and all their geographic positions, for instance in terms of latitude and longitude.

Alternatively, the digital scanner 1 may be connected to the web 11 and connects to that database in order to obtain directly the actual geographic position of the transceiver station 20 through the information contained in the third section 28 (such as Cell ID). This would allow to send directly to the entity (such as a bank), the actual geographic position.

Yet another alternative would be one in which the digital scanner 1 downloads, in advance, a digital file comprising the data of said database. The digital file would contain all the information of the actual geographic position of all the transceivers stations 20 of the cellular network. The digital file may be stored in memory means of the digital scanner 1 or of the geographic detecting means 9. The digital scanner 1 would then be able to retrieve locally the actual geographic position, without the need for a web connection very frequently.

With reference to FIG. 7, there is shown a second flowchart of the method according to the invention applied to a money transaction from a check to a bank.

At step 46, the digital scanner 1 acquires a check and generates a digital track of the same. Subsequently, at step 48, the digital scanner 1 obtains the geographic position information using one or more steps of the method of FIG. 5.

At step 50, the digital scanner 1 encrypts the digital track of the check and the obtained geographic position information and combines them together in a digital stream.

At step 52, the resulting digital stream is transmitted to a predetermined entity in charge of its reading, in particular to the bank, by the transmission means 8. The transmission can take place for example through the web 11. Therefore, at step 54, the bank, or the generic entity, receives the digital stream.

At step 56, the digital stream is decrypted by a processor 13 of an entity (for example the bank) in order to extract the geographic position information, for example the MCC and MNC, and/or Cell ID codes.

At step 58, the processor 13 of the bank converts the geographic position information in geographical coordinates, such as latitude and longitude. This step is possible because the processor 13 may be connected to a database which stores all the geographical coordinates associated with a Country (MCC/MNC), and/or a particular transceiver station 20 (Cell ID), or may already contain them in its own memory.

At step 60, the processor 13 checks if the area identified by the geographical coordinates is permitted. If the area is not permitted, at step 62 the money transaction is not allowed. It should be noted that at step 62 the money transaction can be locked, indicated by a warning to the bank or to other competent authorities, suspended, and so on.

If the area is permitted, at step 64, the money transaction is completed and accepted. Therefore, the amount the check is credited to an account of the bank.

The method according to the invention can be implemented via a computer program product loadable into a memory of said digital check scanner 1 and/or of said geographic detecting means 9 and/or of said processor 13 of the entity (bank) and comprising software code portions adapted to implement the method itself.

From the foregoing description, therefore, the characteristics of the present invention, are become apparent as well as its advantages.

A first advantage of the system and method for the traceability of checks with improved functionalities and relative digital scanner according to the present invention is to obtain information on own geographic position in an autonomous way and to operate in closed environments, since the radio coverage of a cellular network is designed to provide its own radio signal even inside buildings.

A second advantage of the system, the method and the digital scanner according to the present invention is to obtain information on own geographic position with an accuracy sufficient to ensure the bank that the transmission of the check comes from areas not subjected to restrictions.

A further advantage of the system, the method and the digital scanner according to the present invention is to comply with the national and international regulations in matters of currency circulation.

A further advantage of the system, the method and the digital scanner according to the present invention is to exploit the existing cellular network in order to obtain the geographic position of the digital check scanner, without changing the cellular network, nor send data thereto, but only to receive.

A further advantage of the system, the method and the digital scanner according to the present invention is to receive a message from a cellular network without the need for a SIM module, or “Subscriber Identity Module”, integrated in the digital check scanner.

There are numerous possible variations of the system and method for the traceability of checks with improved functionalities and relative digital scanner described as an example, without departing from the principles of novelty inherent in the inventive idea, as it is clear that in its practical implementation, the forms of the illustrated details can be different, and the same may be replaced with technically equivalent elements.

Indeed, a possible variant is characterized by the fact that the geographic detecting means 9, in particular a USB flash drive “dongle”, are connected to a processor (not shown in the figures) which in turn is connected to the digital check scanner 1. In this case, the processor controls the operation of the digital scanner and the geographic detecting means 9 are adapted to detect their own geographic position, which corresponds to that of the digital scanner 1, as connected to and residing in the same place. Even in this case, the geographic detecting means 9 are to be intended as associated with the digital scanner 1; therefore also the reception means 14, included in the geographic detecting means 9, are associated with the digital check scanner 1.

Therefore it is easily understandable that the present invention is not limited to a system and a method for the traceability of checks with improved functionalities, and relative digital scanner, but it can be subjected to various changes, improvements, replacements of equivalent elements and parts without however departing from the idea of the invention, as better specified in the following claims.

1. A digital check scanner, said digital scanner being associated with reception means for receiving a message by a transceiver station belonging to a cellular network, said message comprising geographic position information.

2. Digital check scanner according to claim 1, wherein said message comprises a first section that identifies a Country.

3. Digital check scanner according to claim 1, wherein said message comprises at least one of the following geographic position information: said first section that identifies a Country; a second section that identifies a service provider of said cellular network; and a third section that uniquely identifies said transceiver station.

4. Digital check scanner according to claim 1, wherein said digital scanner is associated with processing/encryption means for encrypting said geographic position information.

5. The digital check scanner according to claim 1, wherein said cellular network is the GSM network, or “Global System Mobile”, said first section represents the MCC code, or “Mobile Country Code”, said second section represents the MNC code, or “Mobile Network Code”, and the third section is the Cell ID code, or “Cell Identifier”.

6. Digital check scanner according to claim 1, wherein said message is of the broadcast type.

7. Digital check scanner according to claim 1, wherein said digital scanner comprises transmission means for sending said encrypted geographic position information to an entity authorized to read them, in particular a bank.

8. Digital check scanner according to claim 1, wherein said reception means are comprised in said digital scanner.

9. Digital check scanner according to claim 1, wherein said reception means are comprised in geographic detecting means associated with said digital scanner.

10. Digital check scanner according to claim 1, wherein said geographic detecting means are adapted to be connected to said digital scanner by means of first interfacing means of said digital scanner and second interfacing means of said geographic detecting means.

11. Digital check scanner according to claim 1, wherein said geographic detecting means are adapted to be connected to a processor which controls said digital check scanner.

12. Digital check scanner according to claim 1, wherein said geographic detecting means comprise an electronic module of a connected or wireless type.

13. Digital check scanner according to claim 10, wherein said first interfacing means and second interfacing means are of a connected or wireless type.

14. System for the traceability of checks, said system comprising a digital check scanner according to claim 1 and at least one transceiver station.

15. Method for the traceability of checks, said method comprising the step of receiving, by reception means associated with a digital check scanner, a message sent by at least one transceiver station belonging to a cellular network.

16. Method for the traceability of checks according to claim 15, said method further comprising the steps of:
encrypting, through processing/encryption means associated with said digital scanner, geographic position information obtained from said message;
transmitting, through transmission means of said digital scanner, said encrypted geographic position information to an entity authorized to read them, in particular a bank.

17. Method for the traceability of checks according to claim 15, said method also providing:
to acquire, by means of said digital scanner, a check generating a digital trace of the same;
to combine together, by means of said digital scanner, said digital track of said check and said geographic position information in an encrypted digital stream;
to transmit, through transmission means of said digital scanner, said encrypted digital stream to an entity responsible for its reading, in particular to a bank;
to decrypt, by a processor of said entity, said digital stream in order to extract said geographic position information;
to transform, by means of said processor of said entity, said geographic position information in geographic coordinates, in particular latitude and longitude;
to verify, by means of said processor, if a geographical area identified by said geographical coordinates is admitted for an electronic money transaction from that check;
to accept, through said processor, the electronic money transaction if said geographical area is permitted;
not to accept, through said processor, said electronic money transaction if said geographical area is not permitted.

18. A computer product which can be loaded into a memory of said digital check scanner and/or of said geographic detecting means and/or of said processor of said entity and comprising portions of software code adapted to implement the method itself.
